(19) United States
(12) Patent Application Publication
(10) Pub. No.: US 2022/0164899 A1
(43) Pub. Date: May 26, 2022

(54) NEAR FIELD COMMUNICATION INFORMATION SHARING

(71) Applicant: Alex Stanford Brown, Carlsbad, CA (US)

(72) Inventor: Alex Stanford Brown, Carlsbad, CA (US)

(21) Appl. No.: 17/533,553

(22) Filed: Nov. 23, 2021

Related U.S. Application Data
(60) Provisional application No. 63/117,794, filed on Nov. 24, 2020.

(51) Int. Cl. G06Q 50/00; G06K 19/07; G06K 19/06; G06Q 30/02

(52) U.S. Cl. CPC G06Q 50/01; G06K 19/0723; G06K 7/10297; G06K 19/06037; G06Q 30/0226; G06K 19/06112

(57) ABSTRACT

A user information sharing system and method provide instantaneous contact-free communication of a providing user's information with another user through use of an electronically readable tag employing proximity communications, such as a near field communications (NFC), or through an interface, such as a quick response (QR) code interface. A portable electronic device of a receiving user may include a processor configured to receive information from such a tag or interface and, in response, request information from a system or server that stores information related to a user associated with the tag. Such information may include information typically found on a business card, social media profile(s), or other information the providing user wishes to share.

### CROSS REFERENCE TO RELATED APPLICATIONS

The present application claims priority to U.S. provisional patent application No. 63/117,794 filed Nov. 24, 2020, entitled SYSTEM AND METHOD FOR USER INFORMATION SHARING, the content of which are incorporated herein in its entirety.

### FIELD OF INTEREST

The present inventive concepts relate to the field of user information and, more particularly, to the sharing of information using near field communications.

### BACKGROUND

People share different types of information for a variety of reasons, for example, for business, for social reasons, for entertainment. Sharing information has been complicated by the presence of viruses and diseases that have brought the dangers of direct contact between people to light. Reliable sharing of information, on a personal level, without direct contact between people and without direct contact between one person and an item another person has had contact with may be achieved in a system and method in accordance with principles of inventive concepts.

### SUMMARY

In accordance with aspects of the inventive concepts, provided is a user information sharing system. The system comprises at least one network-accessible server comprising a user information sharing program executable by at least one processor to input and establish a plurality of user accounts to the server, and at least one electronically readable tag comprising a unique tag identification (ID) and a link to the server. The tag is configured with a predefined link to the server. The server creates and assigns a unique identification number (UID) to each user account, and records the relationship between each user account and a tag ID. In response to access to the server by the action of accessing the link inside the tag, either direct link access or reading the content inside the tag, the server is configured to establish the user account information for association with the tag ID, and generate a webpage that includes information to be inputted from the user account.

In various embodiments, the tag is a near-field communication (NFC) tag.

In various embodiments, the NFC tag is readable by a user device to link to the webpage to receive the shared information.

In various embodiments, the NFC tag is readable by the user device to link to the webpage to enable editing of the user information.

In various embodiments, the user device comprises a proximity communications interface configured to communicate with the tag to receive the tag ID and the link to the server and a user information sharing app executable by a processor of the user device to render the user interface and communicate entered user information to and/or from the server.

In various embodiments, the user information sharing app is executable to write the link to the web page on the tag.

In various embodiments, the user information sharing app is executable to generate a QR code embodying the tag ID and the link to the server.

In various embodiments, the QR code is readable by a receiving user device to link to the webpage to receive the shared information.

In various embodiments, the user information includes at least one of links to social media profiles of the user and/or links to gaming profiles of the user.

In various embodiments, the user information sharing program is executable by at least one processor of the server to access one or more social media accounts and/or one or more gaming accounts of the user to retrieve at least some of the user information.

In various embodiments, the server is configured to implement a point system associated with sharing user information among the plurality of user accounts, wherein the system is configured to award points on a user account basis that incentivizes increased sharing of user information.

In accordance with aspects of the inventive concepts, provided is a user information sharing method. The method comprises: providing an electronically readable tag comprising a unique tag identification (ID) and a link to a network-accessible server; the tag reading information from a user device and generating a link from the user device to the server that includes the tag ID; the server establishing a user account that includes the tag ID, generating a user interface on the user device requesting entry of user information for association with the user account and tag ID, and generating a link to a webpage that includes information to be shared from the user account, in response to the user device accessing the server via the link.

In various embodiments, the tag is a near-field communication (NFC) tag.

In various embodiments, the method comprises communicating the link to the webpage comprising the shared information to a receiving user device in response to the receiving user device communicating with the NFC tag.

In various embodiments, the method comprises enabling editing of the user information and the association of the user account with the tag using the user information sharing program.

In various embodiments, the method comprises the user device communicating with the tag to receive the tag ID and the link to the server; and communicating entered user information from the user device to the server.

In various embodiments, the method comprises the user device writing the link of the web page to the tag.

In various embodiments, the method comprises the user device generating a QR code embodying the UID link to the server.

In various embodiments, the method comprises, in response to a receiving user device reading the QR code, linking the receiving user device to the webpage to receive the shared information.

In various embodiments, the user information includes at least one of links to social media profiles of the user, and/or links to gaming profiles of the user.

In various embodiments, the method comprises the server retrieving at least some of the user information from one or more social media accounts and/or one or more gaming accounts of the user.

In various embodiments, the method comprises implementing a point system associated with sharing user information among the plurality of user accounts, including awarding points on a user account basis that incentivizes increased sharing of user information.

In accordance with another aspect of inventive concepts, a system may provide instantaneous contact-free communication of a user's information with another through use of a near-field communication (NFC) chip, which may be embedded in a tag, an information sharing application, which may be provided to a NFC capable electronic device, such as a smartphone and a server executing an information sharing computer program to store and share one or more users' information (such as personal information, business information, social media profiles, etc.) with another user.

In example embodiments a portable electronic device includes a proximity communications interface; a processor configured to: receive information including a user's unique identifier from the proximity communications interface; to supply the user's unique identifier to a server; and to request information from the server related to the user associated with the unique identifier.

In example embodiments a portable electronic device includes a processor configured to provide information retrieved from the server to a receiving user.

In example embodiments a portable electronic device includes a processor configured to supply profile information retrieved from the server.

In example embodiments an electronic information sharing system includes a proximity communications enabled tag; a proximity communications enabled portable electronic device; and a server configured to store information related to a user associated with the proximity communications enabled tag, wherein the proximity enabled portable electronic device includes a processor configured to respond to information received from the tag by retrieving information from the server related to the user associated with the tag.

In example embodiments an electronic information sharing system includes a proximity communications enabled tag that stores a user identifier and link.

In example embodiments an electronic information sharing system includes a proximity enabled portable electronic device that includes a proximity communications interface; a processor configured to: receive information including a user's unique identifier from the proximity communications interface; to supply the user's unique identifier to a server; and to request information from the server related to the user associated with the unique identifier.

In example embodiments an electronic device includes a processor that is further configured to provide information retrieved from the server to a receiving user.

In example embodiments an electronic device includes a processor configured to supply profile information retrieved from the server.

In example embodiments a system includes a proximity enabled tag configured to store a user's unique identifier and a link to initiate server operations in a portable electronic device that interacts with it through a proximity communications interface.

In example embodiments a system includes a proximity enabled tag that includes a near-field communications (NFC) interface.

In example embodiments a system includes a proximity enabled tag that includes a quick response (QR) code interface.

In example embodiments a system includes a server configured to store information related to a user's profile.

In example embodiments a system includes a server configured to store information related to multiple profiles for a given user.

In example embodiments a system includes a server configured to store incentive information.

In example embodiments a system includes a plurality of portable electronic devices and a server configured to store and rank information related to user interactions with tags.

In example embodiments a system includes a portable electronic device that is a cellular phone.

In example embodiments a method for information sharing includes a proximity communications enabled tag storing a unique user identifier and a link to an information sharing process; a proximity communications enabled portable electronic device receiving the identifier and link from the tag; and a server storing information related to a user associated with the proximity communications enabled tag, wherein the proximity enabled portable electronic device includes a processor that responds to information received from the tag by retrieving information from the server related to the user associated with the tag.

In example embodiments a method for information sharing includes a proximity enabled portable electronic device including a processor that, in response to receiving information including a user's unique identifier from the proximity communications tag, supplies the user's unique identifier to a server; and requests information from the server related to the user associated with the unique identifier.

In example embodiments a method for information sharing includes a processor providing information retrieved from the server to a receiving user.

In example embodiments a method for information sharing includes an electronic device with a processor supplying profile information retrieved from a server.

In example embodiments, each tag may be coded with a unique identification number, and a user may have a plurality of tags and may associate and/or attach one or more of the tags to their mobile and/or desktop device.

In example embodiments a tag may include an NFC ID and be able to generate bar and/or QR codes. In some embodiments, all codes may match or be independent of one another. A providing user may share any or all of the codes with a receiving user or place the tag in a location for a receiving user to discover.

In example embodiments, each providing user may determine which information a particular receiving user may have access to and the server may employ machine learning and browser and device fingerprinting to determine which receiving user is accessing tag information.

In example embodiments a providing user may share such things as non-fungible tokens (NFT), which have a complex set of rules regarding sharing. The server may employ artificial intelligence (AI), in the form of machine learning, for example, to identify the providing user and share what that user allows to be shared and to examine a non-fungible token (NFT) contract to ensure that the correct credentials are provided to access the NFT or other information. In example embodiments, if the identity of the person scanning the tag cannot be determined using AI, sharing of the information on the tag may be blocked or at least limited.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A is a block diagram of an embodiment of an NFC-enabled information sharing system, in accordance with principles of inventive concepts;

FIG. 1B is a block diagram of an embodiment of an architecture within which an NFC-enabled information sharing system, in accordance with principles of inventive concepts may be implemented;

FIG. 2 is a flow diagram illustrating an embodiment of a setup process between an NFC-enabled device, an NFC tag, and a user information sharing system, in accordance with principles of inventive concepts;

FIG. 3 is a flow diagram illustrating an embodiment of another process flow among an NFC-enabled device, an NFC tag, and a user information sharing system, in accordance with principles of inventive concepts;

FIG. 4 is diagram of an embodiment of data structures, in accordance with principles of inventive concepts;

FIG. 5 is a chart of an embodiment of a point system implementation of the NFC-enabled information sharing system, in accordance with principles of inventive concepts;

FIG. 6 is a chart of an embodiment of engagement incentives that may be employed within the NFC-enabled information sharing system, in accordance with principles of inventive concepts;

FIGS. 7A and 7B are profile and front views, respectively, of an embodiment of an NFC tag, in accordance with principles of inventive concepts; and

FIG. 8 is an example embodiment of a webpage of a providing user, in accordance with aspects of the inventive concepts.

### DETAILED DESCRIPTION

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items. The term “or” is not used in an exclusive or sense, but in an inclusive or sense.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor. Process steps illustrated in example flow charts may be executed in order(s) other than that illustrated and additional steps may be added or illustrated steps may be deleted without deviating from the spirit of inventive concepts.

In various embodiments, the inventive concepts relate to a mobile phone application (app) that is configured to motivate and enable the sharing of social media profiles in an easy manner. The mobile phone app can be referred to as a user information sharing app or application. Users have personal contact information, many social media profiles, such as Facebook, TikTok, Instagram, twitter, etc. In various embodiments, the mobile phone app, in collaboration with a remote user information sharing server, will collect those social media profiles in one place for easy reference and store the profiles for a user (providing user) and a link to a webpage or to a page within the app to allow other users (receiving users) to see the profiles. The profile information on the web page is editable by the providing user. The application will allow the providing user to write to a near field communication (NFC) chip or device a uniform resource locator (URL) for page having the profiles or links to the profiles of the providing user and could include other profile information beyond.

Providing users will be able to choose their desired profile(s) to associate with their NFC tag with this user information sharing app. These users can also choose the specific account that they can share (Direct Turned On), e.g., Facebook but not Twitter. So once their NFC tag is scanned by a mobile device configured to read NFC tags, that specific account will be shared and can be directly accessed by the mobile device that scanned the NFC tag.

The user information sharing app can also share information with devices not configured to read NFC tags through, for example, the generation of a QR code by the user sharing information app on the user's phone. Therefore, in such embodiments, the providing user can share the QR code and the non-compatible mobile device will be able to get access to the user's profile page.

In preferred embodiments, the user information sharing app supports a wide variety of items that it can write: from the phone number and email address of the providing user to social media, payment apps, gaming, messaging app accounts, and websites.

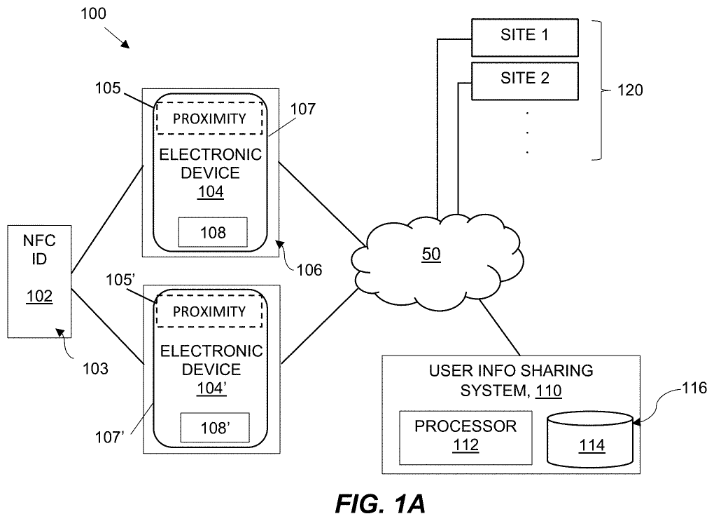

Referring to FIG. 1A, provided is a diagram of an embodiment of an architecture of a system 100 that supports user information sharing, in accordance with principles of inventive concepts are shown. The user information sharing architecture may include one or more electronically readable tags (or tokens) 102 and at least one user information sharing server 110 executing a user information sharing computer program 116. The system 100 can include or interface with one or more portable electronic user devices 104, e.g., mobile phones, responsive to and/or capable of communicating with the token 102. In various embodiments, a user that shares its information and profiles can be referred to as a “providing” user operating a user device 104 and a user that accesses and/or receives the shared information can be referred to as a “receiving” user operating a user device 104′. In various embodiments, a user can be a providing user when sharing its information and profiles and can be a receiving user when accessing or receiving shared information and profiles of another user.

The portable electronic user device 104 may be, for example, a cellular mobile phone or smartphone, a tablet, a smartwatch, a health monitor, or any other portable electronic device. In various embodiments, the user device 104 can include and/or execute a user information sharing application (app) 106 configured to communicate with the tag 102 and the server 110. And the user information sharing server 110 can include and/or execute a user information sharing computer program 116 to communicate with the tag 102 and the user device 104 of a providing user and, in some embodiments, with the user device of a receiving user 104′.

The server 110 can include or have access to at least one processor 112 configured to execute the user information sharing computer program 116 and at least one data storage device 114 to store executable program code, tag information, and user account information. Server 110 may be configured to communicate over any of a variety of types of networks, e.g., the World Wide Web, Internet, and/or cellular networks, collectively referred to as network 50.

The server 110 executing the user information sharing program 116 can communicate with the providing user device 104 to set up a user account, including associating the tag ID with the user account. Setting up the user account can also include storing and/or associating user-provided links to the providing user's social media accounts, i.e., links to social media sites and systems 120. In some embodiments, the providing user's device 104, which includes a display 107 and a processor 108, can execute the user information sharing app 106 to communicate with the tag 102 and the server 110 to establish, maintain, manage, and edit its user account in the data storage device 114.

The providing user device 104 can also include a proximity communications interface 105 that enables communication with the electronically readable tag 102. In various embodiments, the electronically readable tag 102 may be configured with or include a near-field communication (NFC) chip 103 to form an NFC tag 102. In example embodiments, NFC tag 102 may take the form of an NFC disk that is relatively inexpensive and, therefore, suitable for wide distribution/deployment. The NFC tag 102 may include an adhesive portion or surface that enables the NFC tag 102 to adhere to a user device 104 or other items or structures. In other embodiments, the NFC tag 102 may include other coupling devices or mechanisms, e.g., cords, clips, hooks, or the like.

Therefore, server 110 can be configured to process requests, instructions, and communications between the user device 104, and, optionally, the electronic devices of receiving users 104′. The processor 112 of the server 110 may also be configured to execute the user information sharing program 116 to apply artificial intelligence (AI) and machine learning techniques to make decisions about communications and information sharing among devices and/or systems. The various functional elements of the system 100 may communicate over any now existing or hereafter developed computer network 50, as noted above.

Like the providing user's electronic device 104, the receiving user's electronic device 104′ may also include a display 107′ and a processor 108′. However, in some embodiments, the receiving user's electronic device 104′ need not include a proximity communications interface 105′ or a user information sharing app 106. In some embodiments, the user information sharing app 106 on the providing user's device 104 may be configured to generate a bar code, QR code, other graphical code, and/or other signal that embodies the NFC ID of the NFC tag 102 and information and/or links that transitions the receiving user's device 104′ to the page with the providing user's shared information, e.g., social media links. Therefore, in various embodiments, the providing user's device 104 can provide an output that enables the receiving user's device 104′ to access shared information of the providing user associated with the NFC tag 102, as established in a user account by the server 110.

If the receiving user's electronic device 104′, e.g., mobile phone, includes a proximity communications interface 105′, then the NFC tag 102 can be read by the receiving user's electronic device 104′. The NFC tag 102 communicates the NFC tag ID and a link to directly or indirectly access a webpage associated with the providing user's account at the server 110. The webpage can include links to one or more social media profiles (or other content) associated with the providing user. The webpage can also include other information associated with the providing user, e.g., name, email address, phone number, photograph(s), interest information, and so one.

Therefore, the server 110 may set up the NFC tag 102 to supply the receiving user's device 104′ with information associated with the providing user, based on a tag ID that associates the NFC tag 102 with the providing user's account on the server 110. The providing user information shared with the receiving user's device 104′ can be based on the information previously supplied to the server 110 via the providing user's device 104.

The server 110 may setup, store, and manage one or more providing user accounts, each user account comprising information to be shared by a providing user. In various embodiments, the user accounts may include user account information comprising personal information, business information, and/or social media profile information. As examples, user account information can include personal or business contact information, including name, address, phone number, and/or email address and/or biographical information of the providing user. The profile information may be provided directly to the server 110 by the providing user using the user information sharing application 106 loaded on the providing user's mobile phone 104 and/or may be provided otherwise to the server 110. The server 110 may be configured to aggregate providing user information from one or more websites 120, such as social media platforms, employment platforms, business home pages, websites, etc.

In various embodiments, a providing user may have a plurality of different tags 102. In some embodiments, some tags could be duplicates. For example, reading each of these duplicate tags causes the server 110 to provide a link to the same webpage with the same user information and links. In some embodiments, different tags could be associated with the different user account information. For example, a providing user may program a plurality of NFC tags 102 via server 110, with different NFC tags having a unique tag identifier and a link to a different set or subset of account information. In some embodiments, a user can have a single account with the server 110, but associate different subsets of information with different tags 102 to enable different user information sharing for the different tags.

As described in greater detail in the discussion related to FIGS. 1B through 7B, additional information associated with games or incentive programs, as examples, may be associated with a user account and made accessible by the server 110 via NFC tags 102.

Referring to FIG. 1B, in example embodiments, a user information sharing system and method in accordance with principles of inventive concepts may employ a near field communications (NFC) device to share user information in a contact-free manner. An NFC device, such as an NFC tag 102 having a unique NFC identification (ID) is provided, and setup up to enable sharing of providing user information with other receiving users. The user information can include links to social media profiles and/or other information. The NFC tag 102 could be pre-loaded with an NFC ID, e.g., at a manufacturing, wholesale, or retail facility. The NFC tag 102 can be attachable to a device, such as a mobile phone, or other apparatus. The NFC tag 102 can be programmed with user information, including a link to a webpage that includes information the user would like to share. The user information could include social media profiles or links to social media profiles, as well as other user information, such as one or more of personal contact information, including telephone number, email address, physical address, business or social associations, employment or other organizations, and/or payment, gaming, and/or messaging app accounts and websites, as examples. In example embodiments, a user may employ a plurality of NFC tags 102, each NFC tag including an NFC IF and a link to a web page with user information. The user can customize and edit the user information and links sharable via the webpage.

In operation, once the NFC tag 102 is set up and loaded with the link to the providing user's webpage, an NFC-enabled device 104′, such as mobile phone or other portable electronic device of another person the user wishes to allow access the shared information, may read an NFC chip 103 of the NFC tag 102 in a known communication manner by positioning the NFC tag 102 and NFC-enabled device 104′ within NFC-reading range of one another. Upon reading the NFC chip 103, the NFC enabled device 104′ follows the link to obtain information to be shared, e.g., a webpage with social media profiles or other information associated with the providing user. The link can be or include a link to the server 110 that, in example embodiments, reads the NFC ID and, based thereon, associates the link with a providing user profile to provide user information or direct the query to a third-party site 120, such as a social media account associated with the providing user. In some embodiments, the NFC tag 102 can include links directly to social media accounts associated with the providing user.

Therefore, in various embodiments, a receiving user's NFC-enabled device 104′ may communicate with the NFC tag 102 to receive a link to the providing user's shared information, e.g., via a webpage. The link from the NFC tag 102 can be directed to the server 110, which can present a page on the NFC-enable device 104′ comprising links to social media profiles of the providing user on various social media sites 120 and, optionally, with other information related to the providing user. In some embodiments, the link from the NFC tag 102 can link directly to one or more social media site 120 to provide access to a social media profile of the providing user.

Therefore, the NFC-enabled device 104′ can receive and open a link provided by the NFC tag 102 to receive information associated with the providing user's profile. In various embodiments, the link can be a deep link to a user information sharing program 116 on the server 110 that enables the sharing, a deep link to the user's social media or other applications for information sharing, and/or links for sharing other information through one or more custom links.

In example embodiments, incentives may be provided for extended sharing of information, as described in greater detail below. Users may have many social media profiles, such as Facebook, TikTok, Twitter, Instagram etc. In example embodiments, the server 110 collects, stores, and associates the profiles with a user account, e.g., for easy reference.

In setting up the user account and an NFC tag 102, the server 110, executing the user information sharing program 116, writes a link to a webpage providing access to the user account in association with an NFC tag 102, to allow other users to see and access the social media profiles or other information stored in the user account in association with the NFC tag ID of the NFC tag 102. This information is editable by the providing user, to which the user account belongs. In example embodiments, an NFC tag 102 may store a URL (uniform resource locator) to the server 110 having information associated with at least one a user. In some embodiments, the server 110 may be used by the providing user to store the URL link on the NFC tag 102 and/or at the server 110.

In example embodiments, a providing user may create and modify at least one user account at the server 110 via the user information sharing application 106 on the user's mobile phone 104 (or other computer), in accordance with principles of inventive concepts. The user information sharing app 106 on the mobile phone 104 may communication with the user information sharing program 116 on the server 110 to set up and modify the user's account and set up at least one NFC tag to be associated with the user account. The user account may include a list of one or more social media profiles belonging to the providing user and other information associated with the user. The server 110 may then generate a user account webpage based on the user account contents provided by the user, and the server may also generate a link to the webpage. The server 110 may then associate the NFC tag 102 ID with the user account and communicate the link to the user webpage to the NFC tag 102. In example embodiments, a user does not need to interact with an NFC tag 102 to make changes to the user account, that can be done between a user device 104 and the server 110.

In various embodiments, however, a user may write such user information contents, e.g., links to social media profiles, directly to the NFC tag 102, via the user information sharing app 106 on the mobile phone 104. In example embodiments, the user information sharing program 116 on the server 110 provides an application interface to the user information sharing app 106 on the mobile phone 104 for a user to add or modify his account on the server 110, then stores and/or updates the account with its social media profiles in the server's database 114. In this manner, a user can, as previously described, change the contents of its user account without having to interact directly with the NFC tag 102.

In example embodiments, a user may choose his desired profile/s to associate with the NFC tag 102 using the user information sharing application 106 on the user device 104 accessing the user information sharing program 116 on the server 110. A user may also choose the specific account(s) that they can share (Direct Turned On), so that, once their NFC tag 102 is scanned by a mobile device 104′ compatible with and configured to read NFC tags, that specific account will be shared and can directly be accessed by the mobile device 104′ that scanned the NFC tag 102.

The server 110 may also share information with non-NFC compatible devices through a generated quick response (QR) code generated on the providing user's device 104 using the user information sharing app 106. By sharing the QR code, or a bar code, the receiving user's device 104′ obtains the NFC ID and link to the webpage of a providing without the receiving user's device 104′ communicating directly with the NFC tag 102.

In example embodiments, NFC chips 103 may store biographical information and a URL link to direct the person scanning the NFC chip to the URL of the webpage of the providing user to receive shared information. In some embodiments, the NFC chip 103 (and NFC 102) can also store basic contact information of the user. In example embodiments, users can write or setup a plurality of NFC tags, using their phone, and then place those NFC tags at any desired location. Some places may be prominent and easily be found, for wide accessibility in a sort of broadcast distribution, or they may be located in obscure places, in a sort of scavenger hunt distribution. The NFC tags may be movable or transportable for others to find, e.g., creating an experience for people to look for and find the NFC tags of other. Each NFC tag may be written with a code so that the user information sharing application 116 of server 110 may identify the user associated with the NFC tag, and its contents, and determine whether the person that scanned the NFC tag is identified as the owner of the NFC tag and, therefore, whether they have access to writing or modifying contents of the user account on server 110 and the NFC tag.

In example embodiments, a manufacturing facility may pre-load an NFC tag 102 (and NFC chip 103) with a link to the server 110 and/or the user information sharing application 116 of the server 110, along with a unique NFC ID. An NFC compatible device, such as a smartphone 104′ with embedded NFC sensor 105′, may read the NFC tag 102 data, open a link to a server 110 provided by the NFC chip and display the content, such as a user's contact or profile information. The server 110 may manage users' metadata and account, NFC tag information, and NFC tag contents, as examples. The server 110 may determine which information, such as business or personal biographical information, to share with an NFC compatible device 104′ that has followed a link to the server 110.

Because, in example embodiments, content is maintained under control of the server 110, a user may set up their interaction with the server 110 by a simple scan of the NFC tag, which then may dynamically control and update the content at the server, in real time. In doing so, user information and social media profile information from the providing user's device 104 may be transferred to the server 110. The server 110 may then create and/or update the user's account and the NFC tag 102. In example embodiments, the NFC tag 102 may be password protected to avoid overwriting. The server 110 may determine whether a user, via a user device, attempting to edit or initiate information via the NFC tag 102 has authority to do so before providing a chip password for editing.

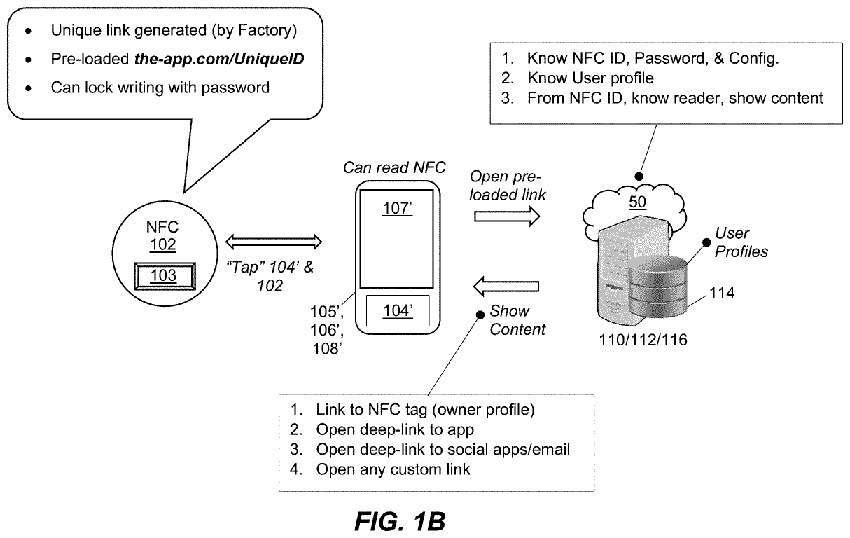

Referring to FIG. 2, provided is an embodiment of a method 200 of setting up an NFC device, such as an NFC tag (or sticker) 102 that includes an NFC chip 103, in accordance with principles of inventive concepts. The server 110 may include the processor 112, a data storage device 114, and a user information sharing program 116 that is executable to carry out the server-side functions of the system and the method. In this example, a user initiates communication between the user's device 104, e.g., a smartphone, and the NFC tag 102. In various embodiments, the NFC chip 103 of the NFC tag 102 can be pre-programmed, e.g., with a unique ID and a link to the server 110, and configured for setup as described herein. For example, at the NFC chip's manufacturing facility, or some other intermediate facility and/or time, the NFC tag 102 (and NFC chip 103) can be configured to collaboratively carry out the method 200 in response to contact or close proximity of the NFC tag 102 and the user device 104.

Referring to the exemplary method 200 of FIG. 2, step 202, communication between the user device 104, such as a smartphone, and the NFC tag 102 may be initiated by “tapping” the user device 104 to the NFC tag 102 or by bringing the user's device 104 within close range of the NFC tag 102, e.g., within a few inches or centimeters.

In step 204, the user's device 104 reads a URL with a unique NFC identifier parameter that has been programmed into the NFC chip 103 of the NFC device 102. The URL can be automatically processed to open and/or initiate an HTTPS request to the server 110, where the processor 112 and the user information sharing program 116 receive and process such request. The server 110 parses the URL format and value to determine whether the indicated NFC tag 102 is “new” (that is, whether it has been assigned to a user or not) in step 206. In step 208, if the NFC tag 102 is new, the server 110 returns to a default webpage for the new user to set up a user account. If the NFC tag 102 has been assigned, so is not new, the server 110 redirects the process to that assigned user's public page, for the user's account.

In step 210, the user's phone 104 displays the results provided by the server 110 and the user's phone determines whether a user information sharing application 106 has been installed on the phone and, if not, the phone displays a mobile webpage facilitating installation of the application 106 on the user's phone.

In step 212, the user information sharing application 106 installed on the user device 104 will be opened and the contents provided by the server 110 (and program 116) will be shown via a display 107 of the user device. Otherwise, if the NFC tag 102 is new, in step 214, the application 106 will request a URL with a unique NFC ID and user ID by which the server 110 assigns the NFC tag 102 to the user. In response, in step 216, the server 110 generates the NFC tag ID and a write protected password for the NFC tag 102. The server 110 assigns and/or relates the user ID to the NFC tag ID and saves NFC tag ID information in its database 114 in association with at least one user account. In step 218, the server 110 replies to the phone 104 by providing the NFC tag ID and a password, which may be randomly generated, to the user device 104. In step 220, the user device 104 receives the NFC tag ID and, through the application 106, writes the URL generated along with the NFC tag ID to the NFC tag 102. The user device then locks the NFC tag 102 with a password to avoid overwriting the NFC tag 102. In step 222, the user device 104 and application 106 prompt the user to fill in the tag metadata and, upon submission by the user, sends the tag metadata to the server 110. In step 224, the server 110 updates the tag metadata associated with the NFC tag ID in the data storage device 114 in association the user account.

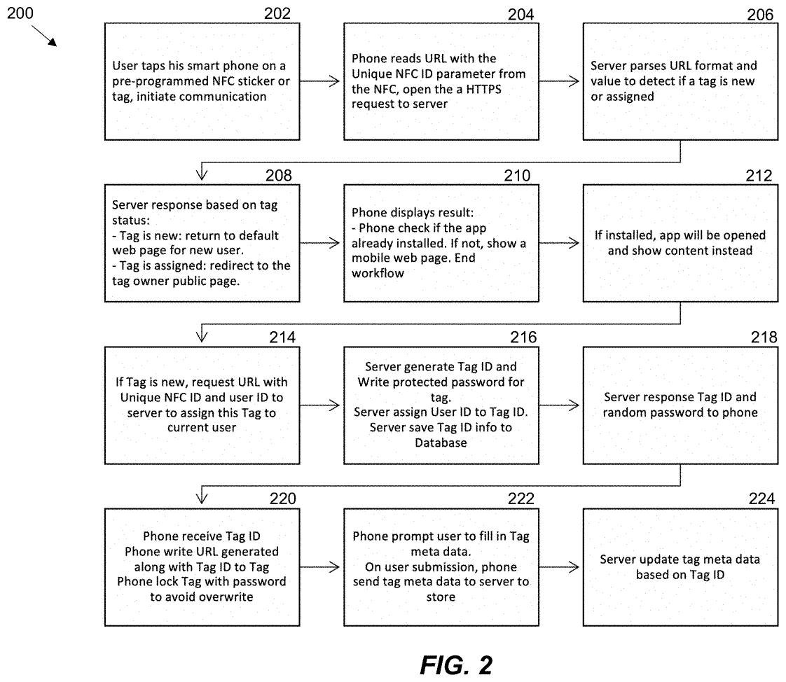

Referring to FIG. 3, provided is a flowchart depicting an embodiment of a method 300 by which the server 110 returns business features in response to communication with an NFC tag 102 that has been assigned to the user device (e.g., smartphone) 104 of a user. The process begins in step 302 where a user “taps” his smartphone on a preprogrammed NFC tag 102, or brings the user device in sufficient close contact with the NFC tag 102 to establish communication between the two, in accordance with principles of inventive concepts. In step 304, the user device 104, equipped with a user information sharing application 106, reads the URL from the NFC tag 102 and opens an HTTPS request of the server 110. In step 306, the server 110 recognizes the NFC tag ID 102 provided by the smartphone 104, applies business (or administrative) features for the NFC tag 102, saves activity for the NFC tag 102, returns business features results along with tag activity ID to the smartphone 104.

In step 308, the user device 104 displays the content returned from the server 110. In step 310, the application 106 on the user device 104 is opened and displays content from the server 110 and requests that the server updates NFC tag 102 activity associated with the current application user in the user's account stored in data storage 114. In step 312, the server 110 updates the user ID to the tag ID in the user's account.

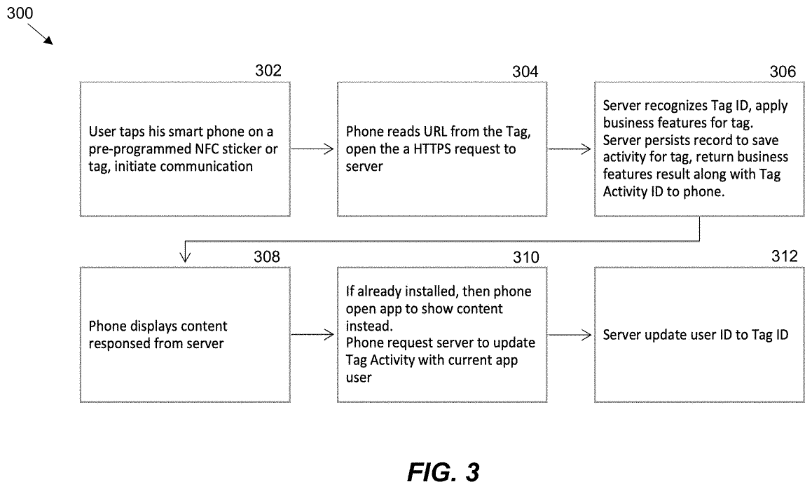

Referring to FIG. 4, provided is a data storage diagram 400 that illustrates an embodiment of data structures that can be employed in accordance with principles of inventive concepts. As illustrated, a user account (or profile) 402 may include basic fields 412 (e.g., first and last names, date of birth, address, a self-description); social media fields 414 (e.g., Facebook, Instagram, YouTube); and/or dynamic fields 416 (e.g., blood type, allergies, user defined fields (with user defined label and value)). A physical NFC tag 102 may include a unique ID (which may be defined at a factory or generated by the system in accordance with principles of inventive concepts), a tag owner ID, user ID, an auto-generated password, tag content ID, and tag locations. The tag locations, may associate tag reads and tag writes and other values as illustrated in FIG. 4. Tag content 101 may be organized using a pre-defined content template that accepts a name card (or name of user), emergency content, whether the tag is personal, social, business, etc.

In example embodiments, the server 110 may provide information related to: a personal profile (business card information, emergency information); advertising (vouchers/discounts—codes, terms of use date—secret pass, ticket, events, invitation letter); lost & found (luggage, pets/children/elderly, computers/gadgets); tags/chips (shop items, books, checkpoint—counter/attendant check, scripting interaction, QR code or barcode without Camera access—smart notes everywhere, share tags among members (notes, interact, tasks) speak to the manager; goods and consumers (authenticate, wearable, NFC trigger and connection). That is, the system and method can be used in business contexts, or other contexts, and it not limited to personal user contexts.

In example embodiments, a community of users may be established and maintained by the system. In such embodiments, rankings may be awarded, for example, on the basis of the number of times a user shares information. Such incentives may be used to drive the widespread sharing of information or within the context of a game, for example. In a game experience, the rankings may include the following rankings based on a user's activity level (e.g., from lowest to highest ranking): Newcomer; Social Surfer; Chatter Bug; Social Netizen; Social Connoisseur; Aficionado; Post Master; Social Dilettante; Elite Engager; Superstar; and Megastar. Other rankings are also contemplated within the scope of the inventive concepts. In various embodiments, the user may begin at a relatively low ranking and be motivated by the granting of points or other tokens of value to move to higher rankings.

In example embodiments, interaction with the server 110, in a game implementation for example, may be incentivized through a plurality of “activity loops” that may be built on top of a points system. An “engagement loop” in accordance with principles of inventive concepts may be the primary set of activities that keep a user engaged with the system (e.g., NFC tag, application, and server). In various engagement loop embodiments, users are rewarded points for every activity in the system and may redeem points at an online store for merchandise, tickets, or other items of value. In example embodiments, the store provides items that enable the user to actively engage with the system. This creates a loop where the user gains points by engaging with the system and redeems the points on items that further encourage more engagement. In example embodiments, a “progression loop” may be implemented using a “level” or “tiered” system whereby a user can progress to higher levels, once the user has acquired a particular amount of points.

In example embodiments, by instantly sharing a profile with whomever a user wants, building their profile leader, owning their customized design, scanning to follow any favorite influencers, and getting points for every activity to get rewards (e.g., prizes and stickers and in-app trophies), an information sharing system and method in accordance with principles of inventive concepts provides entertainment along with a useful information-sharing method. These activities can be carried out by the server 110 executing the user information sharing program 116, in collaboration with the smartphone app 106 of one or more user devices 104 and one or more NFC tags 102.

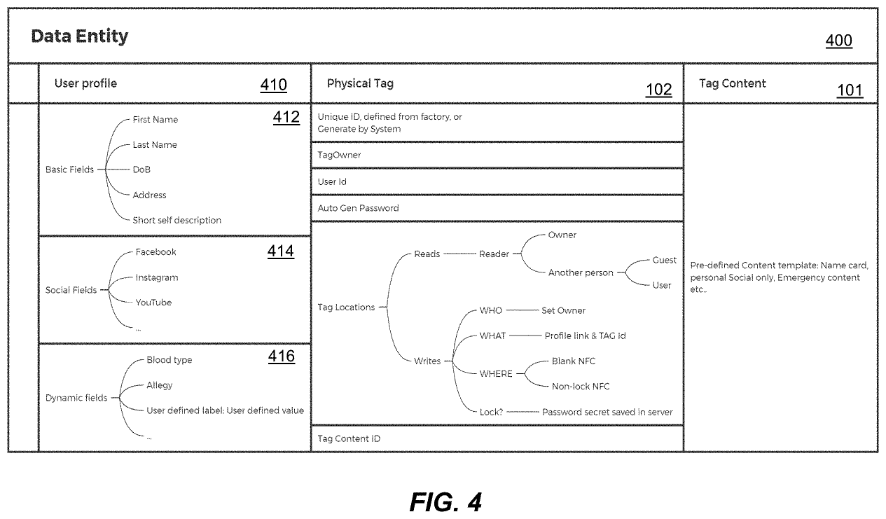

POINTS: In a game environment, a system and method in accordance with principles of inventive concepts may employ tools such as points, badges, leaderboards, and a progression system for expanding a network of scanned NFC tags to enhance a user's information sharing experience. FIG. 5 provides a table of an embodiment of some activities and their associated point value assignments, corresponding to the relative value of the activity, that may be employed in a game environment in accordance with principles of inventive concepts. As may be observed, creating a biographical profile may only be done once and it can be designated to provides a ten point value, inviting a friend to participate could provide a twenty point value, etc. These point values are incentives to take the desired action, which can be used to grow a community.

BADGES: In addition to the points, users may be awarded with badges for certain actions. In some embodiments, the badges may divided in two groups—collectables and discoverables.

COLLECTABLES: In some embodiments, collectables may be badges that are constantly shown in the users' profiles. The users can see what they can win and what they should do to win them. Those badges are used to set goals and guide the users to perform useful activities in the system (for example, they will know in advance that they will be awarded if they create all their accomplishment activities).

DISCOVERABLES: In some embodiments, discoverables are badges that also award the active users, but they are not shown in advance. A system in accordance with principles of inventive concepts may use them to give users a sense of surprise, which is also important for an engaging system. Users will thereby be encouraged to find more NFC tags to collect them and their users' information.

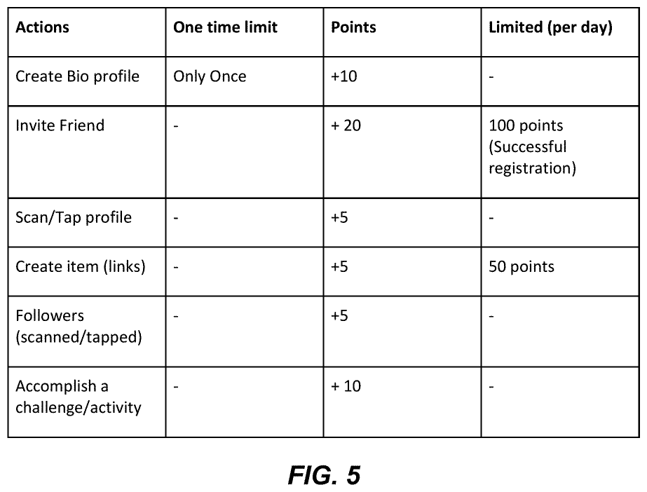

STREAKS: In example embodiments, the user information system, e.g., server 110 executing the user information sharing program and in communication with the user information sharing app 106 of one or more user devices 104, may encourage users to visit the system platform regularly, at least once per day, for example. The system may award a user for maintain a streak of visits (hourly, daily, weekly, for example). As illustrated in the exemplary embodiment of FIG. 6, a streak of visits that is maintained for a period of time (50, 150, 250 days, for example) may provide a correspondingly accelerating multiplier for point rewards (2, 3, 4 times, for example).

OTHER POTENTIAL APPLICATIONS: As previously indicated a user information sharing system, e.g., the server 110 executing the user information sharing program 116, in collaboration with the smartphone app 106 of one or more user devices 104 and one or more NFC tags 102, in accordance with principles of inventive concepts, may be used and provide value in a wide variety of contexts and applications.

In various embodiments, a user of a user device 104 can use the system to establish and share a profile. The profile can be personal profile or it can be a business profile. Once the profile is established, a first user's profile can be shared with a second user by the second user bringing their user device (e.g., smartphone) into contact with or in close proximity to the NFC tag 102 associated with the first user.

A personal profile can include personal profile information as discussed above, e.g., name, phone number, marital status, social media identifications, email address, photo(s), and/or emergency contact information. For individuals with medical conditions, the personal profile information could include medical information, e.g., doctor contact information; allergy information, prescribed medications, medical conditions (e.g., diabetic, schizophrenic, etc.), and so forth. In some embodiments, the personal profile information could include interest and/or affiliation information, e.g., religion, political party, hobby information, favorite sports teams, languages spoken, and so forth.

A business profile can include business profile information, e.g., name, title, phone number, email address, company name, company webpage link, professional certifications, educational information, list of skills, and/or social media profile information (LinkedIn profile, Twitter handle, etc.). The business profile information could take the form of an electronic business card.

In various embodiments, the information sharing system could be used in an advertising context, wherein the information sharing system could be configured to store and share advertising and promotional information via a properly configured NFC tag. The advertising and promotional information could include vouchers, coupons, discount codes, terms of use or expiration date, product and price information, invitations and/or promotional event tickets, as examples.

In various embodiments, the information sharing system could be used in a lost & found context, e.g., to help identify luggage, elderly, computers/gadgets pets, children belonging to or under the care of a user.

In various embodiments, the NFC tags/chips can be attached to or associated with shop items, books, and other goods or services, used as a checkpoint or transaction control device and system, e.g., at a checkout counter and/or an attendant checkpoint, where the server (and NFC tag) can be used for scripting interactions. In some embodiments, the NFC tag could be used to facilitate QR code and/or barcode processing in the absence of a Camera or scanner. In some embodiments, the information sharing system could be used in a lost could be sed to share notes, documents, or other information, e.g., smart notes everywhere.

In some embodiments, the information sharing server and the NFC tag could be used to authenticate an individual. In some embodiments, the NFC tag could take the form of a wearable.

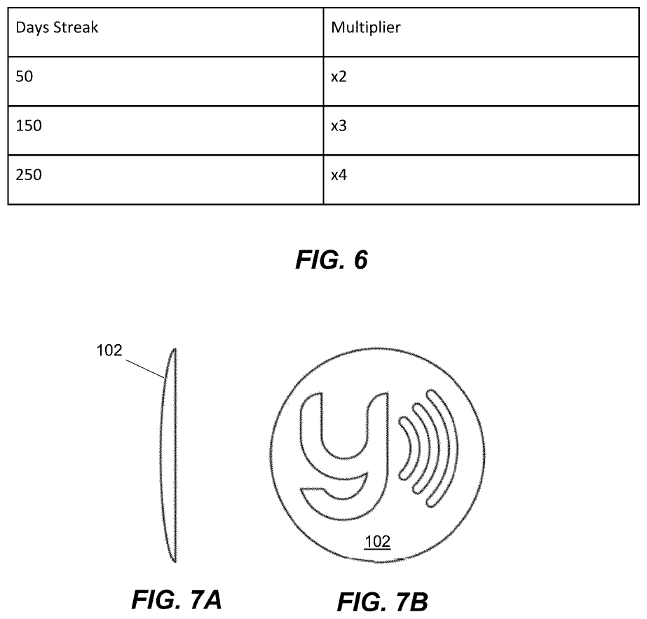

FIGS. 7A and 7B are profile and front views, respectively, of an NFC tag 102 in accordance with principles of inventive concepts. The tag 102 may include an NFC chip 103. In various embodiments, the NFC chip 103, as noted above, has been pre-programmed with a URL link and identification at a manufacturing facility such that, when engaged with by an NFC enabled user device 104, the URL directs the user device 104 to a server 110 that consolidates, maintains, and distributes user information, e.g., social media profiles, business card type contact information, etc. The NFC tag 102 may be configured for attachment to a portable electronic device, such as a smartphone, or to fixed locations (e.g., to a location for advertising, such as a corkboard that typically has business cards pinned to it, display structures, building structures, furniture, tradeshow booths, etc.), or other fixed or moving items. In some embodiments, the NFC tag may be configured to attachment to equipment or vehicles, e.g., cabs, ride share vehicles, trains, buses, boats, airplanes, etc.

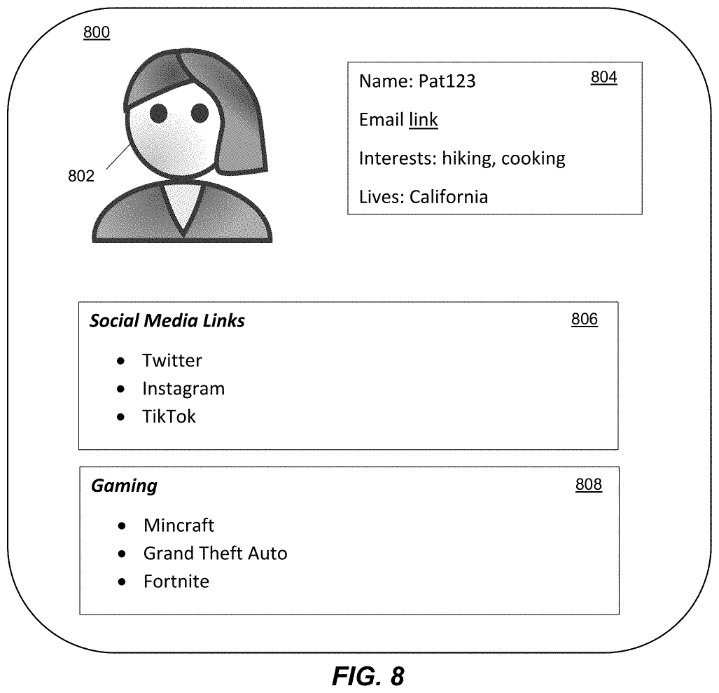

FIG. 8 is an example embodiment of a webpage 800 of a providing user, in accordance with aspects of the inventive concepts. The NFC tag 102 may provide a link to a providing user to use such a webpage interface to set up and update the user account on the server 110. For receiving users, operating device 104′, the link may launch the webpage as a manner of sharing the providing user information. In various embodiments, the webpage 800 may include a photo or the providing user 802. The webpage 800 may also include one or more of personal information 804, such as name, email link, interests, and location. In various embodiments, the webpage may also include a social media links section 806 wherein links to social media accounts of the providing user can be presented. In various embodiments, the webpage may also include a gaming section 808 wherein links to the providing user's gaming profiles can be presented. Other information and sections can optionally be provided.

These examples are not meant to be exhaustive, other information, alerts, and detection mechanisms are contemplated within the scope of inventive concepts. In example embodiments a system in accordance with principles of inventive concepts may be employed in a “check in” environment. That is, a user may book a reservation (for dinner, for travel, for appointments, as examples) from a reservation system (e.g., OpenTable® for a dinner reservation) and, upon arrival at the restaurant, check-in using the NFC tag rather than meeting a receptionist at the restaurant's front desk. In the restaurant context, as an example, after using the NFC tag 102 the cell phone 104 could get a message indicating if the table was ready and directing the individual to their table with a link to a menu.

Other applications are envisioned within the scope of inventive concepts. For example, a system in accordance with principles of inventive concepts may be employed in public transportation, such as at a bus stop, train station, and/or airport. In such an application, the NFC tag 102 may be “tapped” or otherwise engaged to transfer information (such as the estimated time of arrival (ETA) and/or departure of one or more buses, trains, or planes to a user's mobile device. Such information would be particularly useful for the visually impaired, when combined with a character recognition/speech generation facility on the user's mobile device. Additionally, because user information may be stored on the server 110, information helpful to a specific user (which bus or train would be best for the user) may be employed by the system to ensure that the user reaches a destination in the most effective manner.

A system in accordance with principles of inventive concepts may be employed in a variety of application areas, including but not limited to those in retail, medical, navigation (indoor and outdoor), education, and tourism, as examples.

In the retail arena, a system in accordance with principles of inventive concepts may implement a speech-based item identification system and voice-enabled packaging for medicine, food, or other retail items. In such embodiments, when an NFC tag 102 on a package is tapped by (or otherwise brought in communication with) a user's mobile device 104, information about the product is transferred to the mobile device and the mobile device may read it aloud to a user using a text-to-speech application or a screen reader, for example. Input to a mobile device, such as voice-input or haptic input may allow a system in accordance with principles of inventive concepts to guide a user through a store and provided information about products encountered in the store, for example.

In the medical arena, a system in accordance with principles of inventive concepts may identify medicines and, employing the user's profile stored on the system's server, make recommendations regarding uses, prescription renewals, safety limits and interactions, and may facilitate transfer of such information to a user's device (e.g., phone and/or personal computer) or account or to the user patient's caregiver, for example.

A system in accordance with principles of inventive concepts may employ NFC tags 102 positioned, indoors or outdoors, to aid a user in navigating an unfamiliar building or landscape, using the user's NFC-enabled mobile device 104 to direct the user (audibly, for example, for a vision-impaired user) to one or more destinations, for example. As previously described, such a system may be employed to provide a user with bus, train, plane, or other public transformation information (what bus, when it arrives, when it departs, and what are its destinations and when does it arrive at them, for example).

In education settings, a system in accordance with principles of inventive concepts may be used to assist in student, teacher, or other (parent or guardian, for example) identification. Other educational uses include the teaching of subject matter and/or characteristics related to an object associated with an NFC tag 102. For example, an NFC-tagged object, when tapped, may transfer information about its shape, construction, composition, origin, history, and so forth to a user.

A system in accordance with principles of inventive concepts may be employed in the area of tourism. For example, a museum may use the system to provide docent services, with NFC tagged exhibitions providing links to relevant information when tapped by a user with an NFC-enabled mobile device. Such information provision is not limited to museums, however. As previously described, locations of interest may also provide such linked information; a tapped NFC tag at Concord Mass.' Old North Bridge may link users to information about the Revolutionary War and specifics about the battle waged there.

Applications contemplated within the scope of inventive concepts can include: payment, travel, media and advertising, social media, authentication, retail, games, and loyalty applications, as examples.

It is intended by the following claims to claim that which is literally described and all equivalents thereto, including all modifications and variations that fall within the scope of each claim.

It is appreciated that certain features of inventive concepts, which are, for clarity, described in the context of separate embodiments, may also be provide in combination in a single embodiment. Conversely, various features of inventive concepts, which are, for brevity, described in the context of a single embodiment may also be provided separately or in any suitable sub-combination. For example, it will be appreciated that all of the features set out in any of the claims (whether independent or dependent) can combined in any given way.

What is claimed is:

1. A user information sharing system, comprising:
at least one network-accessible server comprising a user information sharing program executable by at least one processor to establish a plurality of user accounts; and
an electronically readable tag comprising a unique tag identification (ID) and a link to the server,
wherein:
the tag is configured to be read by a user device and generate a link from the user device to the server that includes the tag ID,
in response to access to the server by the user device via the link, the server is configured to establish a user account that includes the tag ID, generate a user interface on the user device requesting entry of user information for association with the user account and tag ID, and generate a link to a webpage that includes information to be shared from the user account, and
the server and/or user device are configured to write a link to the web page on the tag.

2. The system of claim 1, wherein the tag is a near-field communication (NFC) tag.

3. The system of claim 2, wherein the NFC tag is readable by a receiving user device to link to the webpage to receive the shared information.

4. The system of claim 2, wherein the NFC tag is readable by the user device to link to the webpage to enable editing of the user information.

5. The system of claim 1, wherein the user device comprises:
a proximity communications interface configured to communicate with the tag to receive the tag ID and the link to the server; and
a user information sharing app executable by a processor of the user device to render the user interface and communicate entered user information to the server.

6. The system of claim 5, wherein the user information sharing app is executable to write the link to the web page on the tag.

7. The system of claim 5, wherein the user information sharing app is executable to generate a QR code embodying the tag ID and the link to the server.

8. The system of claim 7, wherein the QR code is readable by a receiving user device to open the link to the webpage to receive the shared information.

9. The system of claim 1, wherein the user information includes at least one of links to social media profiles of the user and/or links to gaming profiles of the user.

10. The system of claim 9, wherein the user information sharing program is executable by at least one processor of the server to access one or more social media accounts and/or one or more gaming accounts of the user to retrieve at least some of the user information.

11. The system of claim 1, wherein the server is configured to implement a point system associated with sharing user information among the plurality of user accounts, wherein the system is configured to award points on a user account basis that incentivizes increased sharing of user information.

12. A user information sharing method, comprising:
providing an electronically readable tag comprising a unique tag identification (ID) and a link to a network-accessible server;
the tag reading information from a user device and generating a link from the user device to the server that includes the tag ID;
the server establishing a user account that includes the tag ID, generating a user interface on the user device requesting entry of user information for association with the user account and tag ID, and generating a link to a webpage that includes information to be shared from the user account, in response to the user device accessing the server via the link; and
writing a link to the web page on the tag by the server and/or user device.

13. The method of claim 12, wherein the tag is a near-field communication (NFC) tag.

14. The method of claim 13, comprising communicating the link to the webpage comprising the shared information to a receiving user device in response to the receiving user device communicating with the NFC tag.

15. The method of claim 13, comprising enabling editing of the user information by linking the user device to the webpage in response to the user device communicating with the NFC tag.

16. The method of claim 12, comprising:
the user device communicating with the tag to receive the tag ID and the link to the server; and
communicating entered user information from the user device to the server.

17. The method of claim 16, comprising the user device writing the link to the web page to the tag.

18. The method of claim 16, comprising the user device generating a QR code embodying the tag ID and the link to the server.

19. The method of claim 18, comprising, in response to a receiving user device reading the QR code, linking the receiving user device to the webpage to receive the shared information.

20. The method of claim 12, wherein the user information includes at least one of links to social media profiles of the user and/or links to gaming profiles of the user.

21. The method of claim 20, comprising the server retrieving at least some of the user information from one or more social media accounts and/or one or more gaming accounts of the user.

22. The method of claim 12, comprising implementing a point system associated with sharing user information among the plurality of user accounts, including awarding points on a user account basis that incentivizes increased sharing of user information.
